(19) United States
(12) Patent Application Publication
(10) Pub. No.: US 2011/0095888 A1
(43) Pub. Date: Apr. 28, 2011

(54) Solar panel assembly with alarms to indicate a removable of a panel

(76) Inventor: Raymond Saluccio, Colonia, NJ (US)

(21) Appl. No.: 12/589,581

(22) Filed: Oct. 26, 2009

(51) Int. Cl. G08B 13/14

(52) U.S. Cl. 340/568.1

(57) ABSTRACT

The present invention provides a solar panel assembly having an alarm system which is actuated when one or more solar panels are removed from the assembly. The assembly includes a plurality of solar panels linked together to form a solar array. An alarm circuit is provided having a plurality of contact switches embedded within two or more solar panels of the solar panel assembly. Each of the contact switches has a first section embedded in one solar panel and a second section embedded in an adjacent solar panel, so that when the first and second sections of the contact switch are in contact with each other the alarm circuit is closed, and there is no audible sound. Movement of one of the solar panels relative to the other separates the contact between the first and second sections of the contact switch, causing the alarm to be actuated, which produces an audible sound or signal to indicate that a theft of one or more solar panels is being attempted.

### FIELD OF THE INVENTION

This invention relates to solar panel assemblies which have embedded magnetic switches placed in the side walls of solar panel modules. When these unseen magnetic switches are actuated, they alert an alarm system which produces audible sound. When a solar panel is moved in any direction, during an attempted theft, the alarm will sound, which prevents theft.

### BACKGROUND OF THE INVENTION

An alarm system specifically designed for solar panel assemblies is required in order to prevent theft of solar panels, which has become a big problem because of the value of solar panels. This applies to both roof installations and ground installations. An object of this invention is to provide an alarm system having magnetic contact switches embedded within the side walls of solar panels or modules. In this manner, if one or more of the solar panels is moved in any direction, this movement will break contact between the magnetic contact switches, so that an audible alarm is sounded to prevent the theft.

This solar alarm system is wired as a single unit acting as an additional alarm system or wired into an existing alarm system. The solar panel is manufactured with the magnetic alarm switching system already embedded in the side walls of said solar panel modules.

This inventions key objective is to safe guard solar panels installations with a undetectable/mechanical alarm systems.

### OBJECTS OF THE PRESENT INVENTION

It is an object of the present invention to provide an alarm system for a solar panel assembly which is actuated when one or more solar panels are removed from the assembly. The audible alarm is triggered to prevent theft.

Another object of the present invention is to employ a mechanical switching system instead of a magnetic switching system to new solar panel assemblies or to existing solar panel arrays.

### SUMMARY OF THE INVENTION

The present invention provides a solar panel assembly having an alarm system which is actuated when one or more solar panels are removed from the assembly. The assembly includes a plurality of solar panels linked together to form a solar array. An alarm circuit is provided having a plurality of contact switches embedded within two or more solar panels of the solar panel assembly. Each of the contact switches has a first section embedded in one solar panel and a second section embedded in an adjacent solar panel, so that when the first and second sections of the contact switch are in contact with each other the alarm circuit is closed, and there is no audible sound. Movement of one of the solar panels relative to the other separates the contact between the first and second sections of the contact switch, causing the alarm to be actuated, which produces an audible sound or signal to indicate that a theft of one or more solar panels is being attempted.

### BRIEF DESCRIPTION OF THE DRAWINGS

FIG. 1 is a perspective view of a solar panel assembly 10 having adjacent solar panels 12, 14 and an alarm circuit 20 having contact switches 30 and 40, as more fully described below.

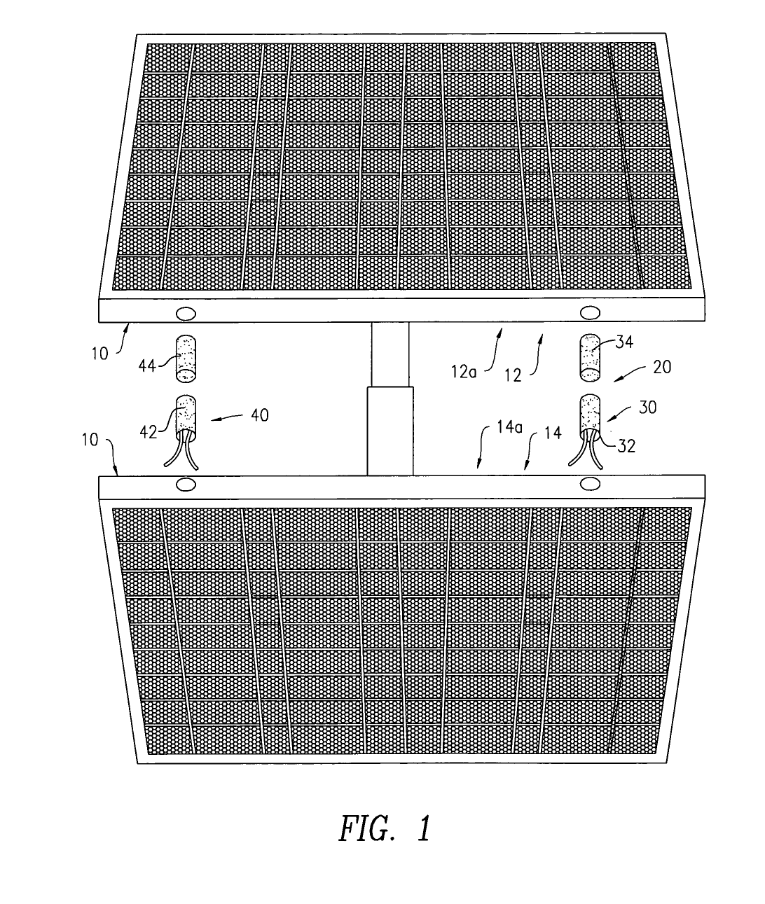

### DETAILED DESCRIPTION OF THE PREFERRED EMBODIMENT

The present invention provides a solar panel assembly 10 having an alarm system 20 which is actuated when one or more solar panels 12, 14 are removed from the assembly 10. The assembly 10 includes a plurality of solar panels 12, 14 linked together to form a solar array. The alarm circuit 20 is provided having a plurality of contact switches 30 and 40 embedded within the adjacent side walls 12a and 14a of two or more adjacent solar panels 12, 14 of the solar panel assembly 10. The contact switch 30 has a first section 32 embedded in one solar panel 14 and a second section 34 embedded in an adjacent solar panel 12, so that when the first and second sections 32, 34 of the contact switch 30 are in contact with each other, the alarm circuit 20 is closed, and there is no audible sound. The contact switch 40 has a first section 42 embedded in one solar panel 14 and a second section 44 embedded in an adjacent solar panel 12, so that when the first and second sections 42, 44 of the contact switch 40 are in contact with each other, the alarm circuit 20 is closed, and there is no audible sound. Movement of one of the solar panels 12, 14 relative to the other separates the contact between the first sections 32, 42 and second the sections 34, 44 of the contact switches 30 and 40, causing the alarm to be actuated, which produces an audible sound or signal to indicate that a theft of one or more solar panels 12, 14 is being attempted.

The present invention may use a mechanical switching system 50 instead of the magnetic switching system in new solar panel assemblies or in existing solar panel assemblies.

### ADVANTAGES OF THE PRESENT INVENTION

The present invention provides the advantage of an alarm system for a solar panel assembly which is actuated when one or more solar panels are removed from the assembly. The audible alarm is triggered to prevent theft.

A latitude of modification, change and substitution is intended in the foregoing disclosure, and in some instances, some features of the invention will be employed without a corresponding use of other features. Accordingly, it is appropriate that the appended claims be construed broadly and in a manner consistent with the spirit and scope of the invention herein.

What is claimed is:

1) A solar panel assembly having an alarm system which is actuated when one or more solar panels are removed from the assembly, comprising:
a) an assembly including a plurality of solar panels linked together to form a solar array;
b) an alarm circuit having a plurality of contact switches embedded within two or more solar panels of said solar panel assembly;
c) each of said contact switches having a first section embedded in one solar panel and a second section embedded in an adjacent solar panel, so that when the first and second sections of the contact switch are in contact with each other the alarm circuit is closed, and there is no audible sound; and
d) movement of one of said solar panels relative to the other separates the contact between the first and second sections of the contact switch, causing the alarm to be actuated, which produces an audible sound to indicate that a theft of one or more solar panels is being attempted.
